(19) United States
(12) Patent Application Publication
(10) Pub. No.: US 2012/0318589 A1
(43) Pub. Date: Dec. 20, 2012

(54) BELT TENSIONING ASSEMBLY FOR AN ENGINE SYSTEM HAVING A MOTOR-GENERATOR UNIT

(75) Inventors: Eric D. Staley, Flushing, MI (US); William C. Deneszczuk, Saline, MI (US); Paul J. Mc Vicar, Troy, MI (US)

(73) Assignee: GM GLOBAL TECHNOLOGY OPERATIONS LLC, Detroit, MI (US)

(21) Appl. No.: 13/526,871

(22) Filed: Jun. 19, 2012

Related U.S. Application Data
(60) Provisional application No. 61/498,878, filed on Jun. 20, 2011.

(51) Int. Cl. F16H 7/12; B60K 6/20

(52) U.S. Cl. 180/65.21; 474/134; 903/902

(57) ABSTRACT

A system for maintaining tension in a drive belt comprises a first belt tensioner that comprises a first pulley mounted on a first lever arm, and a second belt tensioner that comprises a second pulley mounted on a second lever arm. The first belt tensioner is configured and positioned to bias the first pulley against the drive belt at a first location following a departure of the drive belt from a pulley coupled to a motor-generator unit and to thereby maintain tension on the drive belt during both driving and driven modes of the motor-generator unit. The second belt tensioner is configured and positioned to bias the second pulley against the drive belt at a second location prior to an approach of the drive belt toward the pulley and to thereby maintain tension on the drive belt at the second location during both driving and driven modes.

### CROSS-REFERENCE TO RELATED APPLICATIONS

The present patent application claims the benefit of priority from U.S. provisional patent application Ser. No. 61/498,878 filed on Jun. 20, 2011, which is incorporated herein by reference in its entirety.

### FIELD OF THE INVENTION

This invention relates to internal combustion engines and, more particularly, to engine accessory drives for BAS powertrain systems and drive belt tensioners for BAS powertrain systems.

### BACKGROUND

Belt Alternator Starter (“BAS”) powertrain systems (herinafter referred to as “BAS powertrains”) for hybrid vehicles differ from conventional, non-hybrid, powertrain systems. In BAS powertrains, the engine crankshaft (i.e., output shaft) is not the sole source of power (i.e., torque) used to draw the drive belt along its path. In BAS powertrains, a number of operating modes may be employed, and power for driving the belt may be supplied not only by the engine, but also by a motor-generator unit (MGU). When a BAS powertrain transitions between operating modes, belt tension at various locations along the belt path typically changes. These changes in tension raise a number of issues for designers of BAS powertrains.

As used herein, the terms driven and driving refer to interactions between various system components and the drive belt. These interactions typically involve engagement of the drive belt with a pulley that is coupled to a shaft of the component. Each of the components is typically configured to rotate in a single operating direction, and when the drive belt acts to oppose that rotation of the pulley (i.e., applies a torque to the pulley in a direction opposite from the direction in which the pulley rotates), then the pulley (and the component that is coupled to the pulley) is said to be driving the belt. When the drive belt acts to reinforce the rotation of the pulley (i.e., applies a torque to the pulley in the same direction in which the pulley rotates), then the pulley (i.e., the component coupled to the pulley) is said to be driven by the drive belt.

It should be noted that the extent to which a drive belt applies a torque to a pulley is directly related to the difference between the tension in the drive belt as it approaches the pulley and the tension in the drive belt as it departs the pulley. When a particular component is driven by a belt, the tension in the belt as it departs the pulley is greater than the tension in the belt as it approaches the pulley, resulting in the application of a net torque to the pulley in the same direction in which the pulley rotates (i.e., tending to reinforce the rotation of the pulley). When a particular component operates so as to drive the belt, the tension in the belt as it departs the pulley is less than the tension in the belt as it approaches the pulley, resulting in the application of a net torque to the pulley in a direction opposite the direction in which the pulley rotates (i.e., tending to oppose the rotation of the pulley).

In a conventional operating mode, an engine of a BAS powertrain delivers power through its crankshaft (i.e., output shaft), applying a torque to its connected pulley. The pulley draws the drive belt along its belt path, whereby the belt imposes a torque on the pulley in opposition to the torque delivered from the crankshaft. Under steady-state operation, the torque applied to the pulley by the output shaft is equal to the torque applied to the pulley by the belt, and power transferred from the engine to the belt is approximately proportional to the product of the pulley speed and the difference in belt tension on the two sides of the pulley. As the belt travels along its path through the components of the BAS powertrain (e.g., the starter-generator, an air-conditioning compressor, a power steering pump, and motor-generator unit (“MGU”)), the belt engages a pulley coupled to a shaft of each component, thereby interacting with the components and transferring power to each of them. As power is transferred, tension in the belt acts to reinforce the rotation of each component.

In this conventional operating mode, it is the engine that drives the belt, and the belt that drives the remaining components such as the MGU, which may produce electrical power. Therefore, in this mode, the pulley coupled to the engine output shaft operates as a driving pulley, and the pulleys coupled to each of the components in the system operate as driven pulleys. In addition, as the accessory drive belt applies a force to rotate the pulley of each additional component, and to thereby deliver mechanical power to that component, each driven component adds tension to the belt such that tension in the belt as it departs each driven component exceeds tension in the belt as it approaches that driven component. Accordingly, tension in the belt is least where it approaches the first driven component in a series of driven components, immediately following the belt's departure from the driving pulley. Similarly, tension in the belt is greatest where it approaches the driving pulley, immediately following the belt's departure from the last driven component in a series of driven components.

In a boost or hybrid operating mode, rather than being driven by the belt, the MGU may be operated so as to assist the engine in driving the belt, thereby supplying power for driving the other accessories. In this mode, the MGU may access and consume stored energy (e.g., electrical energy from a battery) in order to produce the power to help drive the belt. In this mode, mechanical power delivered by the MGU to the belt may be sufficient to power all other accessories such that the torque applied at the engine output shaft is neutral, and therefore the tension in the belt does not change as it interacts with the output shaft pulley.

In boost or start modes, mechanical power delivered by the MGU to the belt may be sufficient to not only drive the accessories, but to also provide additional power to aid in cranking the engine (e.g., for starting the engine or for augmenting the power delivered through the crankshaft to an output transmission such as for a vehicle). In such boost or start modes, the MGU is operated so as to drive the belt, and the belt helps to drive the engine. Accordingly, in boost or start modes, the pulley coupled to the output shaft of the engine is driven by the belt such that tension in the belt departing the output shaft pulley exceeds tension in the belt as it approaches the output shaft pulley.

As discussed above, tension in the drive belt as it approaches a driven component is less than tension in the drive belt as it departs the component. These regions of differing tension in the belt are generally referred to as taut and slack sides associated with each pulley, with the slack side being the side having relatively less tension. As each component contributes tension, regions of differing belt tension occur along the path of the belt. Accordingly, one or more belt tensioner may be required in such systems. In addition, idler pulleys are often used to shorten drive belt spans to minimize the potential for slack to develop in the drive belt.

From the above discussion, it should be appreciated that the distribution of tension at various locations in the path of a drive belt depends upon the mode(s) in which the components engaging the belt are operating. Moreover, it should be appreciated that if/when a component transitions from one operating mode to another, the tension in the drive belt at a particular location in the belt path may also change. In addition to the mode changes discussed above, accessories such as air conditioning compressors may intermittently turn on or off. As a result, the distribution of tensions along the belt path may change—even though crankshaft speeds remain constant, and even though there may have been no change between operating modes. Still further, as the speed of the crankshaft changes, and thus, as the speed of the accessory drive belt and the driven accessory components changes, the tension imparted to the belt by each component may change. As a result, variable operation of the system within a single operating mode may entail transient changes in the distribution of tensions in the accessory drive belt.

During conventional engine-driven operation of the MGU and other accessories, the loads placed on the drive belt are determined by the power required to drive the accessories, including the MGU unit. The accessory drive loads may be relatively light and, accordingly, may require only moderate to low belt tensioning to avoid belt slippage. On the other hand, during other modes such as boost modes or engine starting wherein the belt is driven by the MGU, the MGU must supply power to rotate the engine (crankshaft, pistons, camshafts, etc.) as well as the accessories. Such modes, and particularly engine starting modes may require a significantly higher level of belt tensioning to control motion on the slack side of the belt (i.e., flapping) and to insure that the belt does not slip.

As a BAS powertrain, such as in a hybrid vehicle, changes operating modes, the distribution of tension in the belt can undergo shifts that are much more dramatic than those experienced during operation within a single operating mode. In operating modes where the crankshaft pulley operates so as to drive the belt, the region of maximum tension in the belt will exist as the belt approaches the crankshaft pulley. Similarly, in operating modes where the MGU pulley operates so as to drive the belt, the region of maximum tension in the belt will exist as the belt approaches the MGU pulley. Thus, as the system transitions between these two modes, or to other modes, extreme transient shifts in the distribution and magnitude of belt tension can occur.

Accordingly, belt tensioners must be configured and arranged to as to not only provide acceptable levels of belt tension, but to also to accommodate and compensate for a variety of tension distributions in an accessory drive belt of a BAS powertrain. Still further, belt tensioners must be able to respond to transient changes in tension distributions. Packaging constraints often necessitate that separate tensioners and idler arms and pulleys with different pivot locations be implemented so as to achieve necessary drive belt geometries. Unfortunately, though, the use of multiple tensioners, idler arms and pulleys may increase the requirements for spacing between components of an accessory drive system and, in some vehicle architectures, may even impose an adverse impact on packaging of the BAS powertrain. Accordingly, belt tensioners must be configured and arranged to as to accommodate, and compensate for, a range of tensions occurring in the accessory drive belt during system operation.

Accordingly, it is desirable to have a belt tensioning assembly that accommodates, and compensates for, substantial variations in the distribution of tension in the path of an accessory drive belt system, such as a BAS powertrain.

### SUMMARY

In a first aspect, an exemplary system for maintaining tension in a drive belt of a BAS powertrain, wherein the BAS powertrain includes an engine and a motor-generator unit, comprises a first belt tensioner that comprises a first tensioning pulley rotatably mounted on a first pivotable lever arm, and a second belt tensioner that comprises a second tensioning pulley rotatably mounted on a second pivotable lever arm. The drive belt defines a belt path configured such that the drive belt engages an engine pulley coupled to an output shaft of the engine and a MGU pulley coupled to the motor-generator unit so as to transfer power between the engine and the motor-generator unit.

The engine is configured to operate in a driving mode, in which the drive belt is driven by the engine pulley, and a driven mode, in which the engine pulley is driven by the drive belt. The motor-generator unit is configured to operate in a driving mode, in which the drive belt is driven by the MGU pulley, and a driven mode, in which the MGU pulley is driven by the drive belt. The first belt tensioner is configured and positioned to bias the first tensioning pulley against the drive belt at a first location on the belt path following a departure of the drive belt from the MGU pulley and to thereby maintain tension on the drive belt during both driving and driven modes of the motor-generator unit. The second belt tensioner is configured and positioned to bias the second tensioning pulley against the drive belt at a second location on the belt path prior to an approach of the drive belt toward the MGU pulley and to thereby maintain tension on the drive belt at the second location during both driving and driven modes of the motor-generator unit.

In a second aspect, an exemplary accessory drive system for a BAS powertrain, which includes an engine and a motor-generator unit, comprises an engine pulley coupled to an engine crankshaft for rotation with the engine crankshaft. An MGU pulley is coupled to an output shaft of the motor-generator unit for rotation with the output shaft of the motor-generator unit. The engine is configured to operate in a driving mode and a driven mode, and the motor-generator unit is configured to operate in a driving mode and a driven mode. The system further comprises a drive belt engaging the engine pulley and the MGU pulley so as to define a belt path and to facilitate transferring power between the engine pulley and the MGU pulley. The system also comprises and a drive belt tensioning assembly mounted to the engine and engaging the drive belt.

In accordance with this exemplary embodiment of an accessory drive system, the drive belt tensioning assembly comprises a first belt tensioner, which comprises a first tensioning pulley rotatably mounted on a first pivotable lever arm, and a second belt tensioner, which comprises a second tensioning pulley rotatably mounted on a second pivotable lever arm. The first belt tensioner is configured and positioned to bias the first tensioning pulley against the drive belt at a first location on the belt path corresponding to a departure of the drive belt from the MGU pulley and to thereby maintain tension on the drive belt during both driving and driven modes of the motor-generator unit. The second belt tensioner is configured and positioned to bias the second tensioning pulley against the drive belt at a second location on the belt path corresponding to an approach of the drive belt toward the MGU pulley and to thereby maintain tension on the drive belt at the second location during both the driving mode and the driven mode of the motor-generator unit.

These and other features and advantages of the invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring the drawings in which:

FIG. 1 is a front view of an engine system that embodies features of the present invention;

FIG. 2 is a perspective view of a motor-generator unit and drive belt tensioners from the engine system of FIG. 1; and

FIG. 3 is a perspective view of a motor-generator unit and drive belt tensioners from the engine system of FIG. 1.

### DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features.

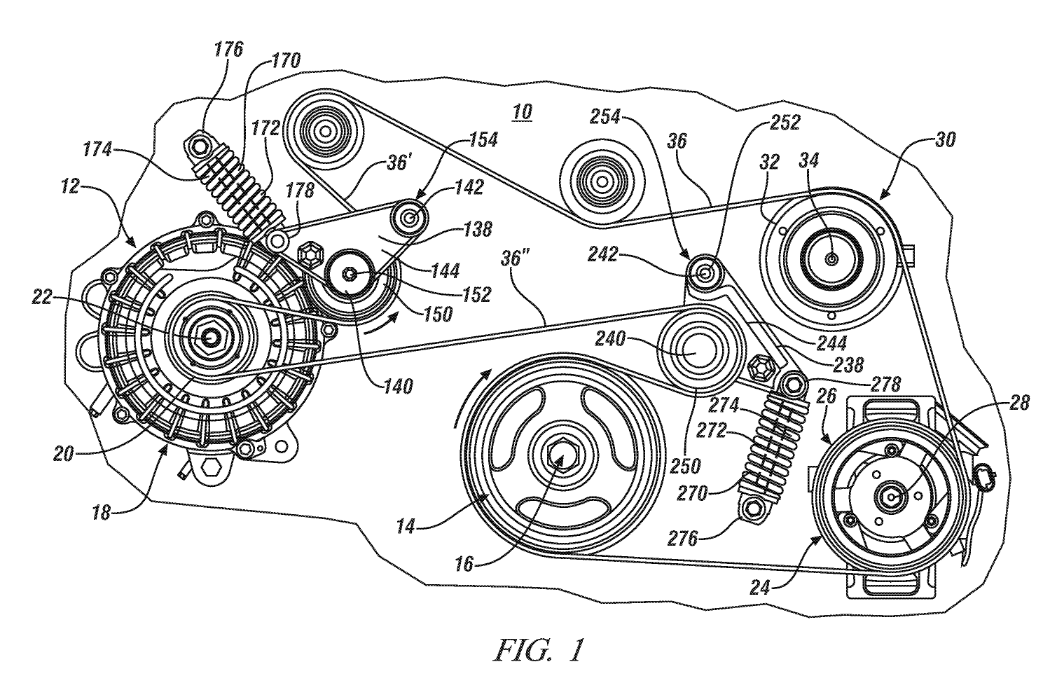

In accordance with an exemplary embodiment, FIG. 1 schematically illustrates a BAS powertrain system 10, for a hybrid vehicle (not shown) having a Belt Alternator Starter (“BAS”) accessory drive system 12. The BAS accessory drive system 12 includes an engine pulley 14 mounted for rotation on the end of an engine crankshaft 16. A Motor-Generator Unit (“MGU”) 18 includes an electric machine that can be driven to act as an electric generator and produce electric power, or use electric power to drive the BAS powertrain system 10 as a starter. MGU 18, operative as a starter/generator, is mounted on the BAS powertrain system 10 at a lateral distance from the engine pulley 14 and includes an MGU pulley 20 mounted for rotation on the shaft 22 of the MGU rotor. An air conditioner compressor 24 may also be mounted on the BAS powertrain system 10 and includes an air conditioner pulley 26 mounted for clutched rotation on the shaft 28 of the air conditioner compressor 24. In addition, a water pump 30 is mounted on the BAS powertrain system 10 and similarly includes a water pump pulley 32 mounted for rotation on the shaft 34 of the water pump 30. Other similarly mounted accessory components, such as an air pump (not shown) or a power steering pump (not shown), may also be associated with the BAS accessory drive system 12. An accessory drive belt 36 is connected between and engages all of the driving and driven pulleys 14, 20, 26, 32 for rotating together the engine crankshaft 16, the MGU 18, the air conditioner compressor 24, the water pump 30 and any other optional accessories. Accordingly, the accessory drive belt 36 defines a belt path engaging the pulleys of the system and facilitates transfer of power between the drive and driven pulleys, and therefore between the engine crankshaft 16 and the MGU 18.

The MGU 18 serves as a generator, as a starting motor, and/or as a boost motor when the vehicle is operating in any of its various hybrid modes. In the generating mode, the MGU is “driven” by accessory drive belt 36. In the starting or cranking or boost modes, the MGU “drives” the accessory drive belt 36. In the illustrated embodiment, the engine crankshaft 16 rotates in a clockwise direction. Therefore, the upper run 36′ of the accessory drive belt 36 is the portion of the drive belt departing the MGU pulley 20 and the lower run 36″ is the portion of the accessory drive belt 36 approaching the MGU pulley 20. In the generating mode, wherein the MGU is driven by accessory drive belt 36, the upper run 36′ of the accessory drive belt 36 is generally tight (i.e., is typically in a state of relatively greater tension) while the lower run 36″ is generally slack (i.e., is typically in a state of relatively lesser tension). This distribution of relative tensions reverses during the starting or cranking or boost modes, wherein the MGU 18 “drives” the accessory drive belt 36. In these modes, the upper run 36′ departing the MGU pulley 20 is generally slack and under less tension, while the lower run 36″ approaching MGU pulley 20 is generally tight and under greater tension.

As one skilled in the art will appreciate, transient conditions such as engine acceleration/deceleration, accessory activation/deactivation, switching between operating modes, intermittent slipping of the belt, and the like, can cause localized belt tension to vary transiently from the above-described typical states. These transient variations can increase the potential for belt slip and/or flapping. Therefore, to properly tension the accessory drive belt 36, the BAS accessory drive system 12 includes one or more tensioners and idler pulleys in order to prevent slippage of the drive belt, such as when the MGU 18 switches from a driven mode to a driving mode.

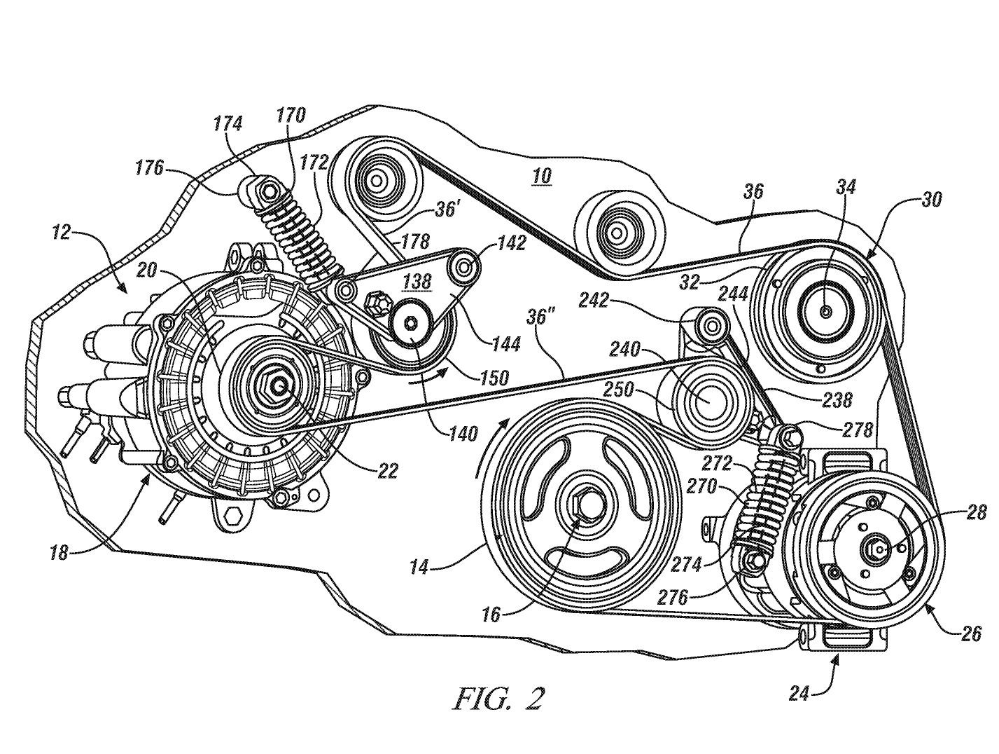

Referring to FIGS. 1-3, in an exemplary embodiment, a first drive belt tensioning assembly 138 includes a pulley support 140 having a pivot 142 and a lever arm 144 extending from the pivot 142. Lever arm 144 includes a tensioning pulley 150 rotatably mounted on shaft 152 at a first location 154 on lever arm 144. A biasing assembly 170 is coupled to lever arm 144 and positioned and configured so as to bias tensioning pulley 150 against accessory drive belt 36 at a location on the accessory drive belt 36 following its departure from the MGU pulley 20. Tensioning pulley 150 is biased to press against accessory drive belt 36 in a direction that tends to increase the tension in the accessory drive belt 36 as the drive belt departs the MGU pulley 20. In this embodiment, tensioning pulley 150 and lever arm 144 are also positioned and configured so that tensioning pulley 150 is biased so as to also tend to increase the extent to which accessory drive belt 36 contacts MGU pulley 20. In some applications, it may be desirable to position one or more idler pulley or another pulley-driven component between the MGU pulley 20 and the tensioning pulley 150 so that the extent of contact between the accessory drive belt 36 and the MGU pulley 20 may be maintained as constant while the tensioning pulley 150 traverses its range of motion about pivot 142.

In an exemplary embodiment, biasing assembly 170 is configured as a linear strut assembly. Accordingly, biasing assembly 170 includes a coil spring 172 and a hydraulic damper 174 disposed between a bias support point 176 on BAS powertrain system 10 and a lever arm attachment point 178 on lever arm 144. In an exemplary embodiment, hydraulic damper 174 is disposed along the central axis of coil spring 172. In this configuration, coil spring 172 is placed in a state of compression when tensioning pulley 150 presses against accessory drive belt 36. It should be noted, however, that other configurations are possible for biasing tensioning pulley 150 against accessory drive belt 36 in a direction that tends to increase the tension in the desired belt location or, in some embodiments, to tend to increase the extent to which accessory drive belt 36 contacts MGU pulley 20. For example, coil spring 172 may be placed in tension with bias support point 176 located such that tensioning pulley 150 is biased against accessory drive belt 36 in the desired direction. In addition, coil spring 172 may be replaced with other biasing means such as a torsion spring configured and positioned to act on lever arm 144 or a cantilever spring integrated with lever arm 144.

It should be noted, however, that by configuring biasing assembly 170 as a linear strut assembly, as shown in FIG. 1, various packaging and design advantages may be realized. For example, when biasing assembly 170 is configured as a linear strut assembly, variations in the geometries of the lever arm 144, the spring characteristics of coil spring 172, and the damping characteristics of hydraulic damper 174 may all be easily manipulated so as to produce desirable performance characteristics of the system while satisfying packaging constraints. For example, in an exemplary embodiment, it may be advantageous to increase or decrease a distance between pulley support 140 and pivot 142. At the same time, it may be advantageous to increase or decrease a distance between pulley support 140 and lever arm attachment point 178.

As one skilled in the art will appreciate, the geometry of lever arm 144, including the various positions and attachment points relative to the position of pivot 142, may be configured along with the positions of bias support point 176 so as to produce a desired range of motion for the tensioning pulley 150 as it acts to maintain acceptable levels of tension in accessory drive belt 36 and to prevent slippage of the accessory drive belt 36, such as when the MGU 18 switches between a driven mode to a driving mode or during other transient events. Still further, it may be advantageous to increase or decrease the stiffness (i.e., spring rate) of coil spring 172 or to adjust the length of coil spring 172 such as by adjusting the location of the bias support point 176. Thus, by configuring biasing assembly 170 as a linear strut assembly, several additional degrees of freedom may be utilized by designers to provide a desirable combination of dynamic characteristics for the system, including maintenance of acceptable tension in the portion of accessory drive belt 36 departing the MGU pulley 20, while meeting competing demands for performance, reliability, packaging efficiency, and weight.

The pulley support 140 and the lever arm 144 are constructed of materials that are selected to exhibit a predetermined degree of flexibility when loaded at the end 154, as will be described in further detail. The material selected for construction of the pulley support may include suitably stiff or flexible metals, composites, laminates or other materials that exhibit stable and repeatable stiffness or flexibility in environments common with engine applications. The structural configuration of the lever arm 144, as well as the stiffness, flexibility, spring rate or material compliance properties (elastic modulus, etc.) of the material will be determined by the forces exerted on the accessory drive system 12 when the MGU 18 is operated in an engine starting mode, as described in further detail below.

The first drive belt tensioning assembly 138 is mounted, at pivot 142, to the BAS powertrain system 10 and is configured to be freely rotatable about the pivot 142. In an exemplary embodiment, this is accomplished by journably mounting the pivot 142 to the BAS powertrain system 10.

With further reference to FIGS. 1-3, in an exemplary embodiment, a second drive belt tensioning assembly 238 includes a pulley support 240 having a pivot 242 and a lever arm 244 extending from the pivot 242. Lever arm 244 includes a tensioning pulley 250 rotatably mounted on shaft 252 at a first location 254 on lever arm 244. A biasing assembly 270 is coupled to lever arm 244 and positioned and configured so as to bias tensioning pulley 250 against accessory drive belt 36 at a location on the accessory drive belt 36 associated with its approach to, (i.e., preceding its engagement with) the MGU pulley 20. Tensioning pulley 250 is biased to press against accessory drive belt 36 in a direction that tends to increase the tension in the accessory drive belt 36 as the accessory drive belt 36 approaches the MGU pulley 20. In this embodiment, tensioning pulley 250 and lever arm 244 are also positioned and configured so that tensioning pulley 250 is biased so as to also tend to increase the extent to which accessory drive belt 36 contacts MGU pulley 20. In some applications, it may be desirable to position one or more idler pulley or another pulley-driven component between the MGU pulley 20 and the tensioning pulley 250 so that the extent of contact between the accessory drive belt 36 and the MGU pulley 20 may be maintained as constant while the tensioning pulley 250 traverses its range of motion about pivot 242.

In an exemplary embodiment, biasing assembly 270 is configured as a linear strut assembly. Accordingly, biasing assembly 270 includes a coil spring 272 and a hydraulic damper 274 disposed between a bias support point 276 on BAS powertrain system 10 and a lever arm attachment point 278 on lever arm 244. In an exemplary embodiment, hydraulic damper 274 is disposed along the central axis of coil spring 272. In this configuration, coil spring 272 is placed in a state of compression when tensioning pulley 250 presses against accessory drive belt 36. It should be noted, however, that other configurations are possible for biasing tensioning pulley 250 against accessory drive belt 36 in a direction that tends to increase the tension in the desired belt location or, in some embodiments, to tend to increase the extent to which accessory drive belt 36 contacts MGU pulley 20. For example, coil spring 272 may be placed in tension with bias support point 276 located such that tensioning pulley 250 is biased against accessory drive belt 36 in the desired direction. In addition, coil spring 272 may be replaced with other biasing means such as a torsion spring configured and positioned to act on lever arm 244 or a cantilever spring integrated with lever arm 244.

It should be noted, however, that by configuring biasing assembly 270 as a linear strut assembly, as shown in FIG. 1, various packaging and design advantages may be realized. For example, when biasing assembly 270 is configured as a linear strut assembly, variations in the geometries of the lever arm 244, the spring characteristics of coil spring 272, and the damping characteristics of hydraulic damper 274 may all be easily manipulated so as to produce desirable performance characteristics of the system while satisfying packaging constraints. For example, in an exemplary embodiment, it may be advantageous to increase or decrease a distance between pulley support 240 and pivot 242. At the same time, it may be advantageous to increase or decrease a distance between pulley support 240 and lever arm attachment point 278.

As one skilled in the art will appreciate, the geometry of lever arm 244, including the various positions and attachment points relative to the position of pivot 242, may be configured along with the positions of bias support point 276 so as to produce a desired range of motion for the tensioning pulley 250 as it acts to maintain acceptable levels of tension in accessory drive belt 36 and to prevent slippage of the accessory drive belt 36, such as when the MGU 18 switches between a driven mode to a driving mode or during other transient events. Still further, it may be advantageous to increase or decrease the stiffness (i.e., spring rate) of coil spring 272 or to adjust the length of coil spring 272 such as by adjusting the location of the bias support point 276. Thus, by configuring biasing assembly 270 as a linear strut assembly, several additional degrees of freedom may be utilized by designers to provide a desirable combination of dynamic characteristics for the system, including maintenance of acceptable tension in the portion of accessory drive belt 36 departing the MGU pulley 20, while meeting competing demands for performance, reliability, packaging efficiency, and weight.

The pulley support 240 and the lever arm 244 are constructed of materials that are selected to exhibit a predetermined degree of flexibility when loaded at the end 254, as will be described in further detail. The material selected for construction of the pulley support may include suitably stiff or flexible metals, composites, laminates or other materials that exhibit stable and repeatable stiffness or flexibility in environments common with engine applications. The structural configuration of the lever arm 244, as well as the stiffness, flexibility, spring rate or material compliance properties (elastic modulus, etc.) of the material will be determined by the forces exerted on the accessory drive system 12 when the MGU 18 is operated in an engine starting mode, as described in further detail below.

The second drive belt tensioning assembly 238 is mounted, at pivot 242, to the BAS powertrain system 10 and is configured to be freely rotatable about the pivot 242. In an exemplary embodiment, this is accomplished by journably mounting the pivot 242 to the BAS powertrain system 10.

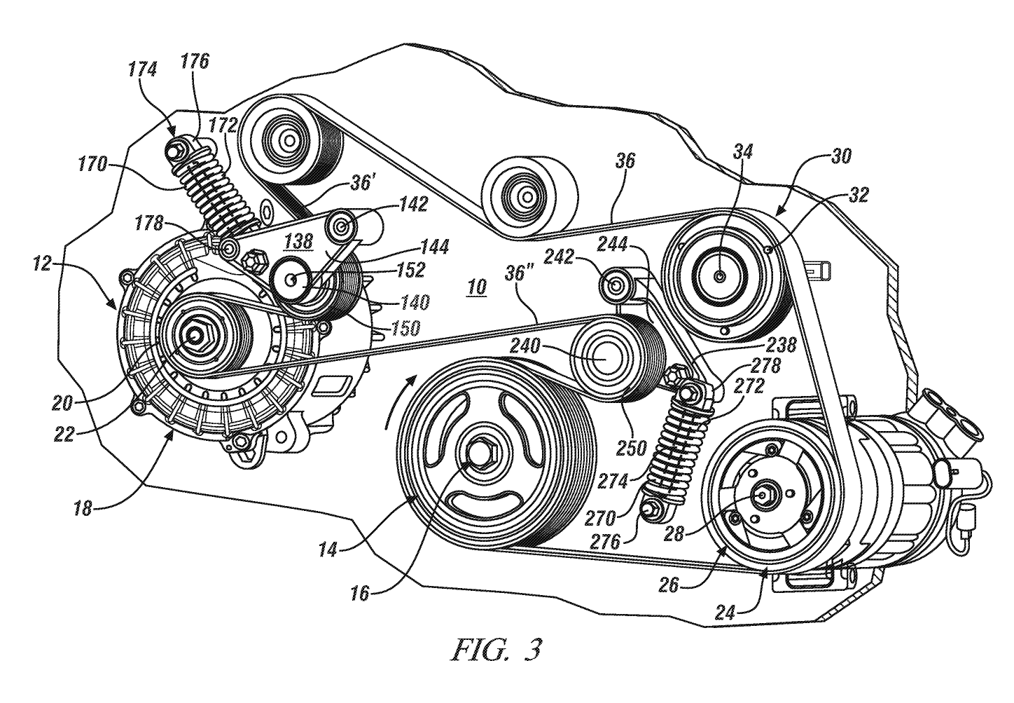

As illustrated in FIGS. 1 and 3, accessory drive belt 36 extends circumferentially about the MGU pulley 20 and the tensioning pulleys 150 and 250 in a serpentine configuration. During operation of the BAS powertrain system 10 in modes wherein the MGU is driven (e.g., by the crankshaft), the tensioning pulley 250 of the second drive belt tensioning assembly 238 applies a biasing force that tends to increase the tension in the relatively slack span 36″ of accessory drive belt 36 departing the MGU pulley 20 to thereby take up any slack that may be present. During operation of the BAS powertrain system 10 in modes wherein the MGU drives the accessory drive belt 36, and thus other components such as the crankshaft that may be coupled to the belt, the tensioning pulley 150 of the first drive belt tensioning assembly 138 applies a biasing force that tends to increase the tension in the relatively slack upper run 36′ (i.e., the relatively slack span) of accessory drive belt 36 approaching the MGU pulley 20 to thereby take up any slack that may be present.

The tensioning forces experienced by the accessory drive belt 36 as a result of the drive belt tensioning assemblies 138 and 238 are relatively moderate, though sufficient to control both belt runs 36′ and 36″ during such operation when the engine is driving the various accessories and the MGU 18. In this manner the forces that are acting on the bearing systems of the various pulleys and accessories are subject to moderate loads sufficient only to drive the accessories and the MGU 18 from the engine pulley 14 without belt/pulley slippage.

During rapid changes in engine speed during transient operation of the BAS powertrain system 10 or, upon transition of the MGU 18 from the driven mode to the engine cranking or starting mode, the force generated on the lower belt run 36″ by the MGU 18 will urge the second drive belt tensioning assembly 238 in a direction resulting in increased storage of energy in the coil spring 272, as the lower belt run is momentarily placed under a rapid and significantly increased tension. As a result, the belt is enabled to accommodate the transient impulse without snapping while the coil spring 272 deforms providing an increase in slack in the lower belt run 36″. At the same time, the force generated on the upper run 36′ will decrease, enabling the first drive belt tensioning assembly 138 to release energy stored in the coil spring 172 as the upper belt run undergoes a momentary, rapid and significant decrease in tension. As a result, the belt is enabled to accommodate the transient impulse without disengaging from any pulleys or slipping on the pulleys or otherwise flapping while the coil spring 172 adjusts so as to take up any excessive development of slack in the upper run 36′.

Biasing assemblies 170 and 270 each produce a biasing action wherein their respective hydraulic dampers are internally designed to move freely as well as biasing the tensioning pulleys 150, 250 against the upper and lower runs 36′, 36″ to maintain the drive belt at a tension which is appropriate for normal, steady state driving of the MGU 18 and the various other engine accessories by the crankshaft mounted, engine pulley 14. However, the hydraulic dampers include internal velocity-sensitive damping features (not shown) that limit the rate of compression caused by forces that may act against it.

By providing a plurality of belt tensioning assemblies 138, 238 that includes multiple tensioning pulleys 150 and 250 that are operable to maintain the proper tension in both upper and lower runs 36′ and 36″ of the accessory drive belt 36, operation of engine assemblies undergoing substantial transient shifts in belt tensioning, such as BAS hybrid engine applications, can be accommodated without the need for major repackaging efforts or engine modifications for each engine/vehicle application.

It should be noted that, in an exemplary embodiment, a drive belt tensioning assembly may include a first drive belt tensioner that is hydraulically damped. Moreover, the second drive belt tensioner may also be hydraulically damped. Still further, both the first drive belt tensioner and the second drive belt tensioner may be hydraulically damped.

As one skilled in the art will appreciate, the first drive belt tensioner operates in response to action of the drive belt and based on geometry and selections of damping and energy absorption characteristics. Similarly, the second drive belt tensioner operates in response to action of the drive belt and based on geometry and selections of damping and energy absorption characteristics. Accordingly, the first drive belt tensioner and the second drive belt tensioner are enabled to operate independently from one another in response to action of the drive belt where the drive belt contacts the respective tensioner.

It should be noted that the first drive belt tensioner may be closely coupled to the motor-generator unit such that no intermediary pulley is interposed between the first drive belt tensioner and the motor-generator unit. Alternatively, an idler pulley (i.e., a pulley requiring only minimal torque in order to rotate as apposed to a pulley driving or driven by an accessory component or the engine) may be interposed between the first drive belt tensioner and the motor-generator unit so as to define and maintain a desired angle of departure and/or approach of the drive belt to/from the motor-generator unit, and thus a desired degree of contact of the drive belt with the motor-generator unit. Similarly, the second drive belt tensioner may be closely coupled to the motor-generator unit such that no intermediary pulley is interposed between the first drive belt tensioner and the motor-generator unit. Alternatively, an idler pulley may be interposed between the second drive belt tensioner and the motor-generator unit so as to define and maintain a desired angle of departure and/or approach of the drive belt to/from the motor-generator unit, and thus a desired degree of contact of the drive belt with the motor-generator unit.

Although the invention has been described primarily with reference to a BAS hybrid engine system is has been contemplated that there are applications for the invention in non-BAS systems that may require a high degree of short-term drive belt tensioning such as in higher performance engines in which rapid speed excursions may frequently be expected and, therefore the invention should not be limited to the descriptive embodiments included herein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed but that the invention will include all embodiments falling within the scope of the present application.

What is claimed is:

1. A system for maintaining tension in a drive belt of a BAS powertrain including an engine and a motor-generator unit, the system comprising:
a first belt tensioner comprising a first tensioning pulley rotatably mounted on a first pivotable lever arm; and
a second belt tensioner comprising a second tensioning pulley rotatably mounted on a second pivotable lever arm;
wherein the drive belt defines a belt path configured such that the drive belt engages an engine pulley coupled to an output shaft of the engine and a MGU pulley coupled to the motor-generator unit so as to transfer power between the engine and the motor-generator unit;
wherein the engine is configured to operate in a driving mode, in which the drive belt is driven by the engine pulley, and a driven mode, in which the engine pulley is driven by the drive belt;
wherein the motor-generator unit is configured to operate in a driving mode, in which the drive belt is driven by the MGU pulley, and a driven mode, in which the MGU pulley is driven by the drive belt;
wherein the first belt tensioner is configured and positioned to bias the first tensioning pulley against the drive belt at a first location on the belt path following a departure of the drive belt from the MGU pulley and to thereby maintain tension on the drive belt during both driving and driven modes of the motor-generator unit, and
wherein the second belt tensioner is configured and positioned to bias the second tensioning pulley against the drive belt at a second location on the belt path prior to an approach of the drive belt toward the MGU pulley and to thereby maintain tension on the drive belt at the second location during both driving and driven modes of the motor-generator unit.

2. An accessory drive system as in claim 1, wherein each of the first and second belt tensioners comprises a biasing assembly configured as a linear strut assembly.

3. A system as in claim 1, wherein the first belt tensioner is hydraulically damped.

4. A system as in claim 1, wherein the second belt tensioner is hydraulically damped.

5. A system as in claim 1, wherein the first belt tensioner is hydraulically damped, and wherein the second belt tensioner is hydraulically damped.

6. A system as in claim 1, wherein the first belt tensioner operates independently from the second belt tensioner.

7. A system as in claim 1, wherein the first belt tensioner is closely coupled to the MGU pulley.

8. A system as in claim 1, wherein the second belt tensioner is closely coupled to the MGU pulley.

9. A system as in claim 1, wherein an idler pulley is interposed along the belt path between the first belt tensioner and the MGU pulley.

10. A system as in claim 1, wherein an idler pulley is interposed along the belt path between the second belt tensioner and the MGU pulley.

11. An accessory drive system for a BAS powertrain that includes an engine and a motor-generator unit, the accessory drive system comprising:
an engine pulley coupled to an engine crankshaft for rotation with the engine crankshaft, the engine being configured to operate in a driving mode and a driven mode;
an MGU pulley coupled to an output shaft of the motor-generator unit for rotation with the output shaft of the motor-generator unit, the motor-generator unit being configured to operate in a driving mode and a driven mode;
a drive belt engaging the engine pulley and the MGU pulley so as to define a belt path and to facilitate transferring power between the engine pulley and the MGU pulley; and
a drive belt tensioning assembly mounted to the engine and engaging the drive belt;
wherein the drive belt tensioning assembly comprises:
a first belt tensioner comprising a first tensioning pulley rotatably mounted on a first pivotable lever arm; and
a second belt tensioner comprising a second tensioning pulley rotatably mounted on a second pivotable lever arm;
wherein the first belt tensioner is configured and positioned to bias the first tensioning pulley against the drive belt at a first location on the belt path corresponding to a departure of the drive belt from the MGU pulley and to thereby maintain tension on the drive belt during both driving and driven modes of the motor-generator unit, and
wherein the second belt tensioner is configured and positioned to bias the second tensioning pulley against the drive belt at a second location on the belt path corresponding to an approach of the drive belt toward the MGU pulley and to thereby maintain tension on the drive belt at the second location during both the driving mode and the driven mode of the motor-generator unit.

12. An accessory drive system as in claim 11, wherein each of the first and second belt tensioners comprises a biasing assembly configured as a linear strut assembly.

13. An accessory drive system as in claim 11, wherein the first belt tensioner is hydraulically damped.

14. An accessory drive system as in claim 11, wherein the second belt tensioner is hydraulically damped.

15. An accessory drive system as in claim 11, wherein the first belt tensioner is hydraulically damped, and wherein the second belt tensioner is hydraulically damped.

16. An accessory drive system as in claim 11, wherein the first belt tensioner operates independently from the second belt tensioner.

17. An accessory drive system as in claim 11, wherein the first belt tensioner is closely coupled to the MGU pulley.

18. An accessory drive system as in claim 11, wherein the second belt tensioner is closely coupled to the MGU pulley.

19. An accessory drive system as in claim 11, wherein an idler pulley is interposed along the belt path between the first belt tensioner and the MGU pulley.

20. An accessory drive system as in claim 11, wherein an idler pulley is interposed along the belt path between the second belt tensioner and the MGU pulley.
